(19) United States
(12) Patent Application Publication
(10) Pub. No.: US 2025/0379828 A1
(43) Pub. Date: Dec. 11, 2025

(54) METHODS FOR SIGNALING OVER CONTROL PLANE FOR DROPPING INDICATION OF EXTENDED REALITY TRAFFIC DATA

(71) Applicant: Telefonaktiebolaget LM Ericsson (publ), Stockholm (SE)

(72) Inventors: Du Ho KANG, Sollentuna (SE); Jose Luis PRADAS, Stockholm (SE); Nianshan SHI, Järfälla (SE); Mohammed Yazid LYAZIDI, Reading (GB)

(21) Appl. No.: 18/874,158

(22) PCT Filed: Jun. 23, 2023
(86) PCT No.: PCT/EP2023/067131

§ 371 Date: Dec. 12, 2024

Related U.S. Application Data
(60) Provisional application No. 63/354,957, filed on Jun. 23, 2022.

(51) Int. Cl. H04L 47/32; H04L 41/0823

(52) U.S. Cl. CPC H04L 47/32; H04L 41/0823

(57) ABSTRACT

A method, system and apparatus are disclosed. A first network node configured to communicate with a wireless device (WD) and a second network node is described. The first network node includes processing circuitry configured to determine a configuration including one or more discarding rules for discarding one or more resources associated with a data unit, cause one or both of the second network node and the WD to be configured with the determined configuration, and cause transmission of a discarding activation request to one or both of the second network node and the WD based on the determined configuration. The discarding activation request requests one or both of the second network node and the WD to activate the one or more discarding rules.

### TECHNICAL FIELD

The present disclosure relates to wireless communications, and in particular, to discarding signaling resources in extended reality environments.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. In particular, 5G features may be used to support extended Reality (XR) and Cloud Gaming, which are some examples of 5G media applications.

XR may be used as an umbrella term for different types of realities and may refer to real-and-virtual combined environments and human-machine interactions, e.g., generated by computer technology and wearables. XR may include representative forms such as Augmented Reality (AR), Mixed Reality (MR) and Virtual Reality (VR), and/or the areas interpolated among them.

Further, an aspect of the role of Edge Computing as a network architecture may be considered to provide and/or support XR and Cloud Gaming, e.g., enabled by 3GPP Release-15 (Rel-15) NR networks. Edge Computing is a concept that enables cloud computing capabilities and service environments to be deployed close to the cellular network. In addition, Edge Computing promises several benefits such as lower latency, higher bandwidth, reduced backhaul traffic, and prospects for several services on application architecture(s) for enabling Edge Applications (e.g., 3GPP Technical Report (TR) 23.758). Edge Applications are expected to take advantage of the low latencies enabled by 5G and the Edge network architecture to reduce end-to-end application-level latencies of typical systems.

Typically, 5G NR may support applications demanding high throughput and low latency, which may be in line with requirements for supporting XR and Edge Computing applications.

FIG. 1 shows an example of challenging characteristics of edge-based XR. Comparing to ultra-reliable low-latency communications (URLLC) services (e.g., Ims latency constraint, and reliability of 10⁻⁵), edge-based XR may have latency constraints/requirement with minimum 5 ms up to a couple of 10 ms and/or reliability requirement up to 10⁻⁴. However, much higher bitrate may be required for XR services (than for other services), where larger file sizes 10 KB-100 KB are processed due to codec inefficiency.

In addition, other traffic characteristics of edge-based XR may demand predetermined dynamics associated with eye/viewport tracking. In some instances, although traffic (i.e., data traffic) may appear periodic, file size may vary as shown in FIG. 2. For example, XR applications may generate traffic periodically with a variable size. When an application packet enters the internet (i.e., is transmitted, received, routed in a network, etc.), the application packet may initially be transmitted into a single Protocol Data Unit (PDU) in the network and/or may be segmented in several PDUs. One application packet could, for example, correspond to one or several Internet Protocol (IP) packets.

With respect to Radio Access Networks, IP packets may arrive to the RAN PDCP layer (i.e., Packet Data Convergence Protocol (PDCP) Service Data Units (SDUs)), and the PDCP layer may be configured to create PDCP PDUs and/or deliver to lower layers. When an IP packet arrives to PDCP, the PDCP layer starts a PDCP discard timer. When the discard timer expires, the PDCP discards the PDCP SDU as well as the corresponding PDCP Data PDU. If the PDCP PDU was delivered to lower layers, PDCP indicates the discard to lower layers. Lower layers such as Radio Link Control (RLC) may discard the PDCP PDUs (RLC SDU) if the RLC SDU or any segment of the RLC SDU has not yet been transmitted to lower layers.

Further, XR Application PDUs may have time constraints, i.e., one or a set of application PDUs may need to reach the receiver within a predetermined time such as with a predetermined latency. If the application PDU(s) is/are not received by the predetermined time, the application PDU(s) is/are not of any use and can be discarded.

Although PDCP may start a discard timer each time a PDCP SDU is received by higher layers, the PDCP layer does not have any indication of how many PDCP SDUs correspond to an application PDU (or how many IP PDUs correspond to one application PDU). IP packets may reach PDCP with certain jitter as they may traverse network segments such as the internet as well as a 3GPP core network. For example, one XR application PDU may be segmented into 5 IP packets, and each IP packet may arrive in sequence or out of sequence to the PDCP layer at times X+delta1, X+delta2, etc. Each packet may have a discard timer running with a predetermined time. Further, the 5 PDCP SDUs (i.e., IP packets) are to be delivered within a defined time budget. If the delay budget for the application packet is consumed, the 5 PDCP SDUs corresponding to the application packet may be discarded even if the PDCP discard timer is running or not.

The value of a current PDCP discard timer may not depend on the number of PDCP SDUs which may correspond to a single application PDU, e.g., because the number of PDCP SDUs which correspond to a single application PDU may vary from application PDU to application PDU. Setting the PDCP discard timer to a fraction of the maximum latency of the application PDU may also impose a fictitious restrictions which may lead to unnecessary discards. For example, if the maximum latency is 10 ms and the PDCP discard timer is set to 2 ms, any single PDCP PDU may be discarded 2 ms after it reaches PDCP. In the example where 5 IP packets are used, the 5 PDCP PDUs may be transmitted at the same time after 7 ms from the reception of the first PDCP SDU, and the 5 PDCP PDUs may be delivered within the latency budget, e.g., 10 ms. However, if the discard timer was a fraction of the latency budget, few packets may be discarded within the fraction of the latency budget.

FIG. 3 shows an example architecture where discarding inefficiencies may be present. In this example, the application generates one or more application PDUs and all of the PDUs share the same latency budget (i.e., PDUs are to be delivered within a maximum latency time). The application may also generate other additional application PDUs with a different latency bounds or may generate PDUs at a later time. These application PDUs may traverse one or more networks or may be directly connected to a 3GPP network. The application PDUs may be adapted (e.g., segmented) by protocols below the application protocol to fit transmission properties. One challenge for the gNB (PDCP) (i.e., network node) may be to identify the PDUs that belong to a set of application PDU set with the same latency bound and the PDUs that are to be delivered first. For example, the PDUs generated in t0 may need to be delivered first than those generated in t1.

A similar challenge may occur with respect to uplink communications. For example, more than one PDCP SDU related to one application PDU may arrive to the PDCP layer from the application layer. A WD may need to receive UL grants to transmit the PDCP SDUs. Further, when the uplink grants do not come within a predetermined time or are not large enough (e.g., have a size less than a predetermined threshold), the time budget to deliver the application PDU may be consumed and there may be still PDCP SDUs related to the application PDU pending for transmission. In this example, PDCP would still aim at transmitting the PDCP

SDUs even if the PDCP SDUs are not useful anymore for the receiving node. Additionally, trying to transmit “late” PDCP SDUs may actually delay other PDCP SDUs related to a second application PDU coming after the first application PDU.

In other words, the current PDCP timer is not efficient for (and/or may be difficult for) handling XR services due to one or more of the following reasons:
An XR application may produce one or more application PDUs which are to be delivered within a delay budget. The application or layers below the application may segment/concatenate the application PDUs.
PDCP may be received from upper layer IP PDUs (if IP is used); however, PDCP does not have any information about how the PDCP SDUs (IP PDUs) map to the application PDUs which are to be delivered within the same latency budget.
The existing PDCP discard timer for single PDCP SDU is not sufficient to handle situations outlined in the bullets above.

When one application PDU which should have been delivered within a certain latency bound is late, then the later application PDUs are no longer needed since the later application PDU may be dependent on the early application PDU for video decoding. Transmitting the corresponding PDCP SDUs/PDUs results in a waste of resources. Further, existing independent discard timer between PDCP SDUs is not appropriate to handle this unique situation of XR traffic, i.e., allowing longer stay of PDCP SDU in the buffer although these are not needed any more from an application perspective. In other words, a method where PDCP uses the PDCP discard timer to discard PDCP SDUs and/or PDUs is not efficient for XR applications.

Further, existing methods/systems are unable to determine (e.g., a network node to determine): an independent frame (I-frame) has been discarded or is going to be delivered outside a packet delay budget; and how the network can discard all PDCP SDUs and PDUs in dependent frames (i.e., B-frames, P-frames) that are associated to the I-frame, and the subsequent frames which are dependent on the I-frame. In addition, in split architectures, the PDCP entity and the entity holding the scheduling buffer could be in different nodes: e.g., in g Node B Centralized Unit (gNB-CU) and g Node B Distributed Unit (gNB-DU); the PDCP entity is in a Secondary Node (SN), in Multi-Radio Dual Connectivity (MR-DC) case).

In sum, existing technologies do not provide an efficient process of discarding resources such as PDUs in frames.

### SUMMARY

Some embodiments advantageously provide methods, systems, and apparatuses for signaling (e.g., over a control plane) one or more indications usable for dropping/discarding resources, e.g., associated with XR traffic data.

In some embodiments, one or more methods for a PDCP entity to discard the PDCP PDUs is described. The PDCP PDUs are to be discarded in B-frames and/or P-frames that are associated to an I-frame or P-frame being discarded or to be discarded.

In some other embodiments, a discarding rule to discard associated PDU Sets are determined and configured via Radio Resource Control (RRC) by the network (i.e., a network node). After configuration, the PDCP entity may activate and/or deactivate the discarding rule, e.g., in the network and/or WD.
In case of an F1 Split architecture, a discarding rule activation/deactivation request is signaled by a network node, e.g., gNB-CU to gNB-DU.
For SN-terminated bearers in case of multi-radio technology dual connectivity (MR-DC), the discarding rule activation/deactivation may be signaled over an interface, e.g., Xn, from the PDCP entity in the SN.

In one embodiment, the discarding rule is configured by the RLC entity. In another embodiment, the discarding rule is preconfigured in the WD, gNB-DU, and/or configured via RRC by gNB-CU where the discarding rule can be signaled over other interfaces/protocols such as XnAP and FIAP.

In some embodiments, the activation/deactivation of an initial state of the discarding rule can be performed via RRC and/or dynamically changed by RRC and/or lower layer, e.g., Medium Access Control (MAC) Control Element (CE).

In some other embodiments, discarding rule configuration is performed a network node such as a network node that is/comprises a gNB-CU and/or PDCP entity. The discarding rule configuration value and/or an initial activation status may be provided via RRC to the WD. The discarding rule may further be activated and/or deactivated using Control Elements at the MAC layer or PDCP layer. For split NG-RAN architecture, activation/deactivation requests can be performed via F1AP. For dual connectivity, the discarding rule may be signaled over XnAP. For SN terminated bearer, SN may notify the discarding rule and activation/deactivation status to MN, such as a network node configured for RRC signaling to the WD. Control Plane and/or User Plane protocol may be used, e.g., where the User Plane protocol is enhanced.

In some embodiments, the discarding rule configuration may be performed by another network node such as a network node that is/comprises a gNB-DU. The discarding rule configuration value may be signaled via MAC/PHY (physical) layers. An initial configuration value may be provided by the gNB-DU with the configuration to the gNB-CU. The discarding rule may be activated and/or deactivated using Control Elements at the MAC layer or PDCP layer. In split NG-RAN architecture, activation and/or deactivation requests can be transmitted/received via F1AP. In dual connectivity, the request (and/or discarding rule) can be signaled over XnAP. Control Plane and/or User Plane protocol may be used, e.g., where the User Plane protocol is enhanced.

The methods, apparatuses, and systems described in the present disclosure are beneficial at least because the network (network node) is prevented from transmitting data which is not useful for a receiver. This can have several advantages, e.g., system capacity is increased since data not useful is not transmitted; latency may be decreased since physical resources can be re-used for other data which could reduce buffers and/or delays; the amount of XR satisfied users in the network may also increase since resources are allocated to data which can meet the given requirements. In addition, a signaling solution is provided over a control plane (CP) to configure and/or provide the discarding rule by the network to the WD. Further, support of discarding rule provisioning in case of dual connectivity is provided.

According to one aspect, a first network node configured to communicate with a wireless device (WD) and a second network node is described. The first network node includes processing circuitry configured to determine a configuration including one or more discarding rules for discarding one or more resources associated with a data unit, cause one or both of the second network node and the WD to be configured with the determined configuration, and cause transmission of a discarding activation request to one or both of the second network node and the WD based on the determined configuration. The discarding activation request requests one or both of the second network node and the WD to activate the one or more discarding rules.

In some embodiments, the one or more resources comprise any one of a frame and a packet.

In some other embodiments, the frame is one of a B-Frame, a P-Frame, and an I-Frame.

In some embodiments, the frame has a protocol data unit set tag, and at least one rule of the one or more discarding rules is usable for PDU set level discarding based on the protocol data unit set tag. The frame and at least one other frame which have the same protocol data unit set tag are discarded when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the activated one or more discarding rules trigger one or both of the second network node and the WD to discard the one or more resources associated with the data unit.

In some embodiments, the processing circuitry is further configured to cause transmission of a discarding deactivation request to one or both of the second network node and the WD. The discarding deactivation request requests one or both of the second network node and the WD to deactivate the one or more discarding rules.

In some other embodiments, the deactivated one or more discarding rules trigger one or both of the second network node and the WD to disable discarding of the one or more resources associated with the data unit.

In some embodiments, one or more of the first network node comprises one of a centralized unit, a packet data convergence protocol entity, and distributed unit; and the second network node comprises one of the distributed unit when the first network node is one of the centralized unit and the packet data convergence protocol entity; and the centralized unit when the first network node is the distributed unit; and one or both of the one or more resources and the data unit is associated with extended reality signaling.

According to another aspect, a method in a first network node configured to communicate with a wireless device (WD) and a second network node is described. The method includes determining a configuration including one or more discarding rules for discarding one or more resources associated with a data unit, causing one or both of the second network node and the WD to be configured with the determined configuration, and transmitting a discarding activation request to one or both of the second network node and the WD based on the determined configuration. The discarding activation request requests one or both of the second network node and the WD to activate the one or more discarding rules.

In some embodiments, the one or more resources comprise any one of a frame and a packet.

In some other embodiments, the frame is one of a B-Frame, a P-Frame, and an I-Frame.

In some embodiments, the frame has a protocol data unit set tag, and at least one rule of the one or more discarding rules is usable for PDU set level discarding based on the protocol data unit set tag. The frame and at least one other frame which have the same protocol data unit set tag are discarded when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the activated one or more discarding rules trigger one or both of the second network node and the WD to discard the one or more resources associated with the data unit.

In some embodiments, the method further includes transmitting a discarding deactivation request to one or both of the second network node and the WD. The discarding deactivation request requests one or both of the second network node and the WD to deactivate the one or more discarding rules.

In some other embodiments, the deactivated one or more discarding rules trigger one or both of the second network node and the WD to disable discarding of the one or more resources associated with the data unit.

In some embodiments, one or more of the first network node comprises one of a centralized unit, a packet data convergence protocol entity, and distributed unit; and the second network node comprises one of: the distributed unit when the first network node is one of the centralized unit and the packet data convergence protocol entity; and the centralized unit when the first network node is the distributed unit; and one or both of the one or more resources and the data unit is associated with extended reality signaling.

According to an aspect, a wireless device (WD) configured to communicate with a first network node and a second network node is described. The WD includes processing circuitry configured to receive a configuration including one or more discarding rules for discarding one or more resources associated with a data unit, receive a discarding activation request associated with the received configuration, where the discarding activation request requests one or both of the second network node and the WD to activate the one or more discarding rules, and discard one or more resources associated with the data unit based on the discarding activation request and the received configuration.

In some embodiments, the one or more resources comprise any one of a frame and a packet.

In some other embodiments, the frame is one of a B-Frame, a P-Frame, and an I-Frame.

In some embodiments, the frame has a protocol data unit set tag. At least one rule of the one or more discarding rules is usable for PDU set level discarding based on the protocol data unit set tag. The method further includes discarding the frame and at least one other frame having the same protocol data unit set tag when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the processing circuitry is further to activate the one or more discarding rules based on the discarding activation request. The activated one or more discarding rules trigger the WD to discard the one or more resources associated with the data unit.

In some embodiments, the processing circuitry is further configured to receive a discarding deactivation request requesting one or both of the second network node and the WD to deactivate the one or more discarding rules.

In some other embodiments, the deactivated one or more discarding rules trigger the WD to disable discarding of the one or more resources associated with the data unit.

In some embodiments, one or more of the first network node comprises one of a centralized unit, a packet data convergence protocol entity, and distributed unit; and the second network node comprises one of: the distributed unit when the first network node is one of the centralized unit and the packet data convergence protocol entity; and the centralized unit when the first network node is the distributed unit; and one or both of the one or more resources and the data unit is associated with extended reality signaling.

According to another aspect, a method in a wireless device (WD) configured to communicate with a first network node and a second network node is described. The method includes receiving a configuration including one or more discarding rules for discarding one or more resources associated with a data unit, receiving a discarding activation request associated with the received configuration, where the discarding activation request requesting one or both of the second network node and the WD to activate the one or more discarding rules, and discarding one or more resources associated with the data unit based on the discarding activation request and the received configuration.

In some embodiments, the one or more resources comprise any one of a frame and a packet.

In some other embodiments, the frame is one of a B-Frame, a P-Frame, and an I-Frame.

In some embodiments, the frame has a protocol data unit set tag. At least one rule of the one or more discarding rules is usable for PDU set level discarding based on the protocol data unit set tag. The method further includes discarding the frame and at least one other frame having the same protocol data unit set tag when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the method further comprises activating the one or more discarding rules based on the discarding activation request, where the activated one or more discarding rules trigger the WD to discard the one or more resources associated with the data unit.

In some embodiments, the method further comprises receiving a discarding deactivation request requesting one or both of the second network node and the WD to deactivate the one or more discarding rules.

In some other embodiments, the deactivated one or more discarding rules trigger the WD to disable discarding of the one or more resources associated with the data unit.

In some embodiments, one or more of the first network node comprises one of a centralized unit, a packet data convergence protocol entity, and distributed unit; and the second network node comprises one of the distributed unit when the first network node is one of the centralized unit and the packet data convergence protocol entity; and the centralized unit when the first network node is the distributed unit; and one or both of the one or more resources and the data unit is associated with extended reality signaling.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example of challenging characteristics of typical edge-based XR;

FIG. 2 shows file sizes associated with a typical XR traffic profile;

FIG. 3 an example system architecture where discarding inefficiencies may be present;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating exemplary methods implemented in a communication system including a host computer, a network node and a wireless device for executing a client application at a wireless device according to some embodiments of the present disclosure;

FIG. 7 is a flowchart illustrating exemplary methods implemented in a communication system including a host computer, a network node and a wireless device for receiving user data at a wireless device according to some embodiments of the present disclosure;

FIG. 8 is a flowchart illustrating exemplary methods implemented in a communication system including a host computer, a network node and a wireless device for receiving user data from the wireless device at a host computer according to some embodiments of the present disclosure;

FIG. 9 is a flowchart illustrating exemplary methods implemented in a communication system including a host computer, a network node and a wireless device for receiving user data at a host computer according to some embodiments of the present disclosure;

FIG. 10 is a flowchart of an exemplary process in a network node f according to some embodiments of the present disclosure;

FIG. 11 is a flowchart of an exemplary process in a wireless device according to some embodiments of the present disclosure;

FIG. 12 is a flowchart of another exemplary process in a network node according to some embodiments of the present disclosure;

FIG. 13 is a flowchart of another exemplary process in a wireless device according to some embodiments of the present disclosure;

FIG. 14 is a flow diagram of an example discarding rule configuration according to some embodiments of the present disclosure; and

FIG. 15 is a flow diagram of an example discarding rule configuration according to some embodiments of the present disclosure.

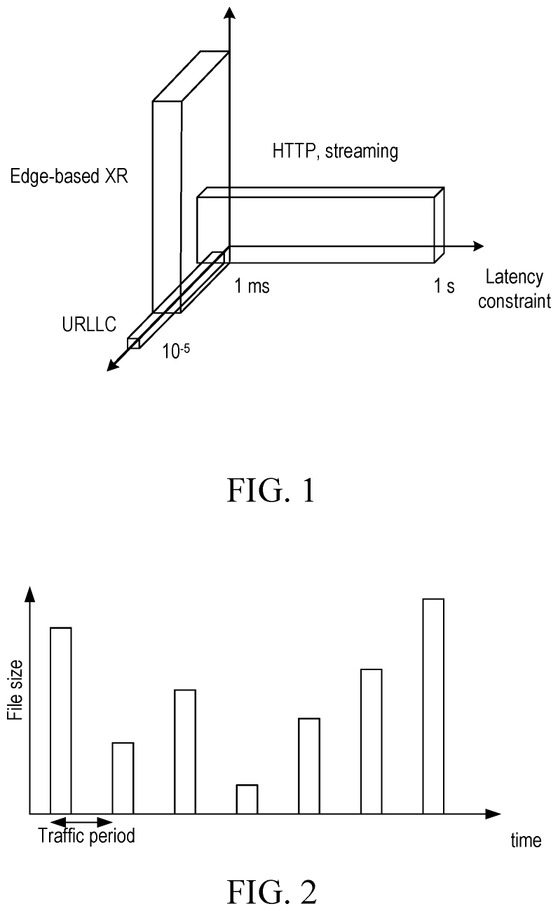

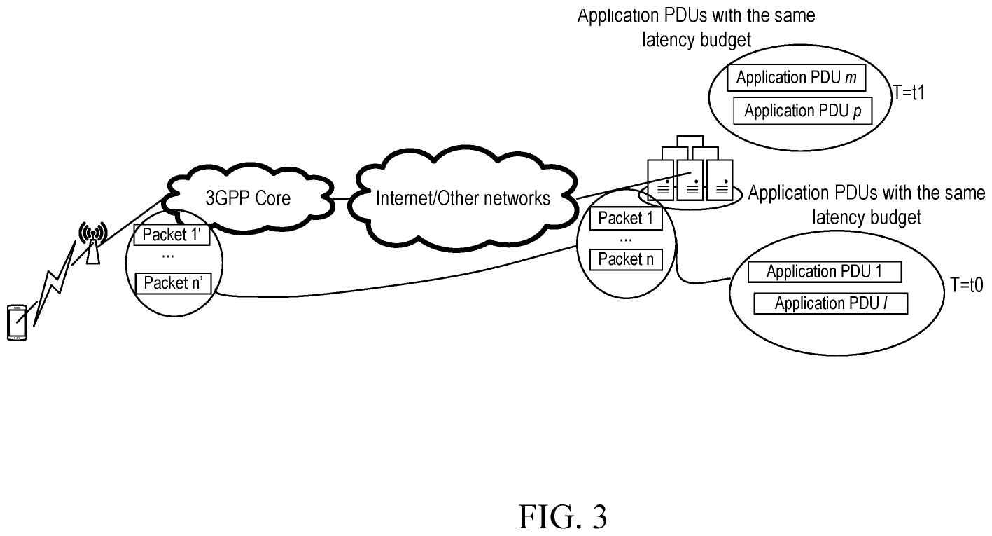

### DETAILED DESCRIPTION

Before describing in detail exemplary embodiments, it is noted that the embodiments reside primarily in combinations of apparatus components and processing steps related to signaling (e.g., over a control plane) one or more indications usable for dropping/discarding resources, e.g., associated with XR traffic data. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” (NN) used herein can be any kind of network node comprised in a radio network which may further comprise any of base station (BS), radio base station, base transceiver station (BTS), base station controller (BSC), radio network controller (RNC), a evolved Node B (eNB or eNodeB), g Node B (gNB), en-gNB (a gNB that can connect with Evolved Packet Core (EPC) and eNB), a centralized unit (CU) such as a gNB-CU, a distributed unit (DU) such as a gNB-DU, a PDCP entity (e.g., a network node configured to perform one or more actions associated with PDCP), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. In some embodiments, two or more network nodes, e.g., gNB-CU and a gNB-DU, may be located in the same physical location such that the two or more network nodes may collectively be referred to as one network node. However, the network node is not limited as such, and each one of the gNB-CU and the gNB-DU may be located in different network nodes. Further, the term network node may refer to a network entity (and/or network function), e.g., a DU, a CU, etc., such that one or more network entities may be implemented in the same physical location and same physical computing/communication node/device. The network node may also comprise test equipment. The term “radio node” used herein may be used to also denote a wireless device (WD) such as a wireless device (WD) or a radio network node.

In some other embodiments, a gNB-DU (i.e., DU) may refer to a logical node hosting radio link control (RLC), medium access control (MAC) and physical (PHY) layers of the network node, i.e., gNB, en-gNB. The operation of the gN-DU may be at least in part controlled by a gNB-CU. One gNB-DU may support one or multiple cells. One cell may be supported by one gNB-DU. The gNB-DU may terminate an F1 interface connected with the gNB-CU. A gNB-CU-Control Plane (gNB-CU-CP) may refer to a logical node hosting radio resource control (RRC) and/or a control plane part of a PDCP protocol of the gNB-CU for a network node (e.g., an en-gNB or a gNB). The gNB-CU-CP may terminate an E1 interface connected with the gNB-CU-User Plane (gNB-CU-UP) and the F1-C interface connected with the gNB-DU.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the term data unit is used and may refer to a protocol data unit (PDU), a service data unit (SDU), etc. In some other embodiments, the term PDU set as used and may refer to one or more PDUs carrying a payload of information.

In some embodiments, the term discard (or discarding) is used. For example, a resource such as a frame or a packet that may be transmitted, received, and/or processed is discarded. Discarding may refer to rejecting as not usable, stopping the transmission, reception, and/or processing of, buffering, deleting, not using, etc. For example, discarding a frame may refer to rejecting the frame as not usable, stopping the transmission, reception, and/or processing of the frame, buffering, deleting, not using the frame, etc.

In some other embodiments, the term discarding rule is used and may refer to a rule usable by one or more devices/nodes to discard a resource. The rule may comprise one or more conditions associated with the resource and/or communication of the resource.

In some embodiments, the term frame is used and may comprise a bi-directional frame (B-Frame), a predicted frame (P-Frame), an intra-frame (I-Frame), and/or any other type of frame. In some embodiments, the frame may be part of signaling transmitted, received, and/or processed by a device/node.

In some other embodiments, the term activation is used and may refer to triggering one or more devices and/or nodes to perform one or more action. An activation may be requested as in an activation request. For example, an activation request may be a discarding activation request configured for activating a discarding rule (and/or a process associated with the discarding rule). Similarly, deactivation may refer to triggering one or more devices and/or nodes to stop performing one or more actions. For example, a deactivation request may be a discarding deactivation request configured for deactivating a discarding rule (and/or a process associated with the discarding rule).

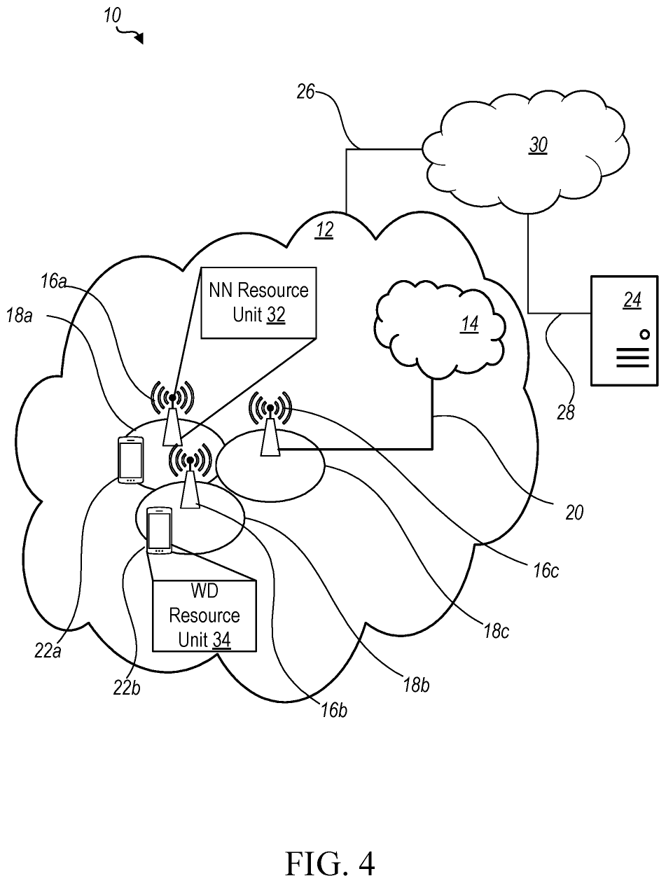

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an NN resource unit 32 which is configured to perform any step and/or task and/or process and/or method and/or feature described in the present disclosure, e.g., determine a configuration including at least a discarding rule for discarding at least one resource associated with a data unit; cause at least one of the WD and second network node to be configured with the determined configuration; cause the transmission of a discarding activation request to the second network node based on the determined configuration, etc. A wireless device 22 is configured to include a WD resource unit 34 which is configured to perform any step and/or task and/or process and/or method and/or feature described in the present disclosure, e.g., receive a configuration including at least a discarding rule for discarding at least one resource associated with a data unit; cause the transmission of signaling based on the received configuration and/or a discarding activation request transmitted to the second network node, etc.

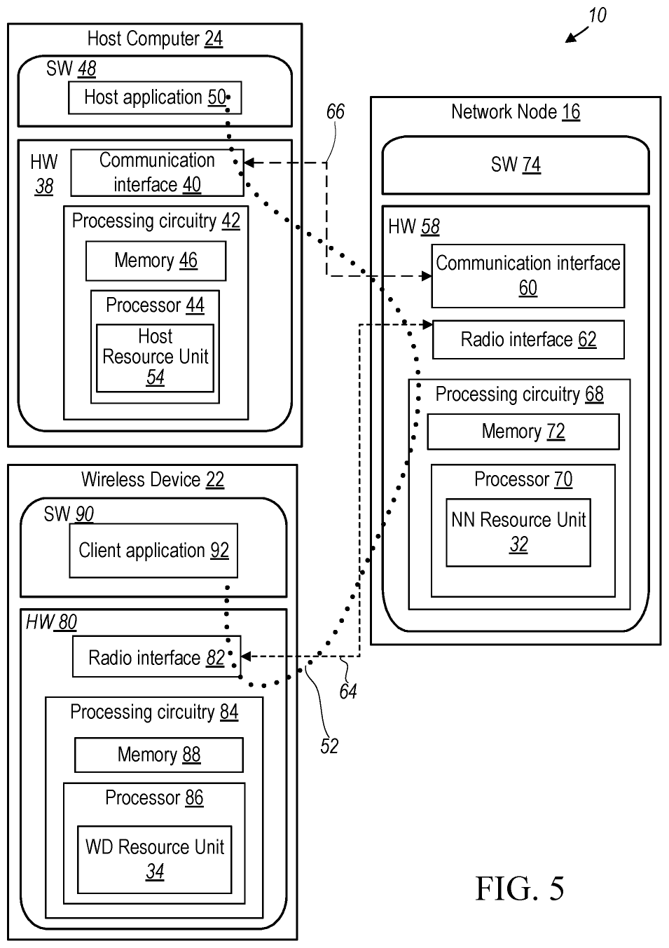

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host resource unit 54 configured to perform any step and/or task and/or process and/or method and/or feature described in the present disclosure, e.g., enable the service provider to observe/monitor/control/transmit to/receive from the network node 16 and or WD 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10. In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN resource unit 32 configured to perform any step and/or task and/or process and/or method and/or feature described in the present disclosure, e.g., determine a configuration including at least a discarding rule for discarding at least one resource associated with a data unit; cause at least one of the WD and second network node to be configured with the determined configuration; cause the transmission of discarding activation request to the second network node based on the determined configuration, etc. Further, NN resource unit 32 may be configured to perform one or more actions associated with a CU, a DU, a PDCP entity, etc. In some embodiments, NN resource unit 32 comprises one or more of a CU (e.g., gNB-CU), a DU (e.g., a gNB-DU), and a PDCP entity (or any other entity configured to perform packet data functions such as packet data convergence protocol functions).

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD resource unit 34 configured perform any step and/or task and/or process and/or method and/or feature described in the present disclosure, e.g., receive a configuration including at least a discarding rule for discarding at least one resource associated with a data unit; cause the transmission of signaling based on the received configuration and/or a discarding activation request transmitted to the second network node, etc.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as NN resource unit 32, and WD resource unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

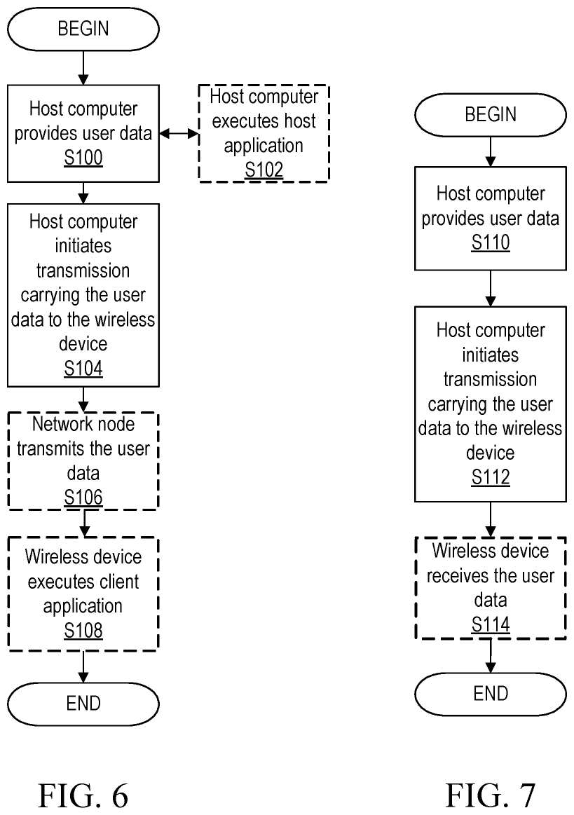

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

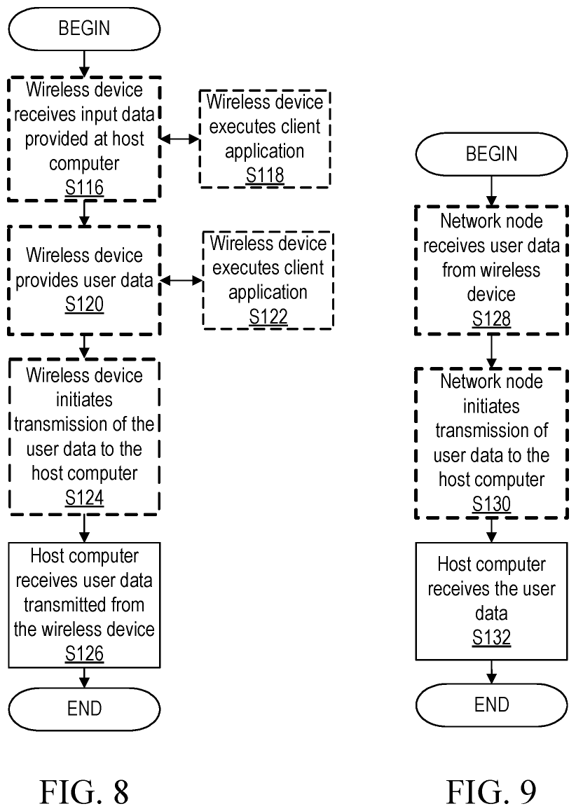

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

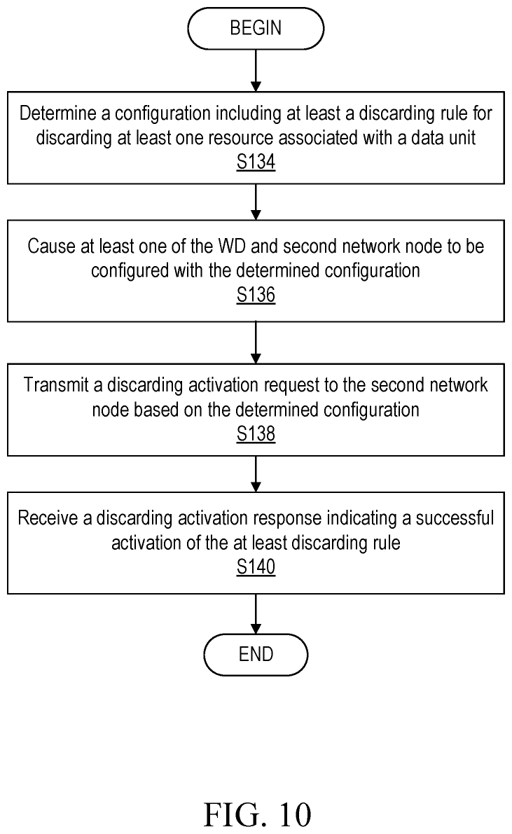

FIG. 10 is a flowchart of an exemplary process in a network node 16 (e.g., a first network node 16a). One or more blocks described herein may be performed by one or more elements of network node 16 such as by one or more of processing circuitry 68 (including the NN resource unit 32), processor 70, radio interface 62 and/or communication interface 60. Network node 16 such as via processing circuitry 68 and/or processor 70 and/or radio interface 62 and/or communication interface 60 is configured to determine (Block S134) a configuration including at least a discarding rule for discarding at least one resource associated with a data unit; cause (Block S136) at least one of the WD 22 and second network node 16b to be configured with the determined configuration; transmit (Block S138) a discarding activation request to the second network node 16b based on the determined configuration; and receive (Block S140) a discarding activation response indicating a successful activation of the at least discarding rule.

In some embodiments, the at least one resource is any one of a frame, and a packet, and the data unit includes any one of a protocol data unit and a service data unit associated with extended reality signaling.

In some other embodiments, the transmitted discarding activation request causes at least one of the first network node 16a, the second network node 16b, and the WD 22 to discard the at least one resource associated with the data unit.

In one embodiment, the first network node 16a is one of a centralized unit, a packet data convergence protocol entity, and distributed unit; and the second network node 16b is one of: the distributed unit when the first network node 16a is one of the centralized unit and the packet data convergence protocol entity; and the centralized unit when the first network node 16a is the distributed unit.

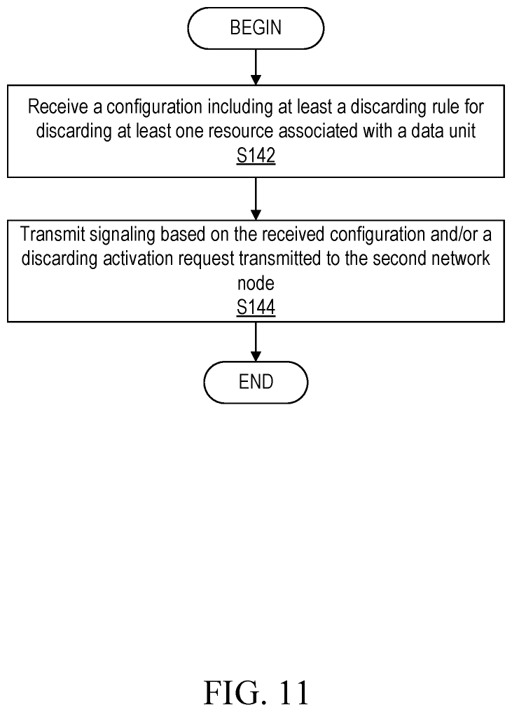

FIG. 11 is a flowchart of an exemplary process in a wireless device 22 according to some embodiments of the present disclosure. One or more blocks described herein may be performed by one or more elements of wireless device 22 such as by one or more of processing circuitry 84 (including the WD resource unit 34), processor 86, radio interface 82 and/or communication interface 60. Wireless device 22 such as via processing circuitry 84 and/or processor 86 and/or radio interface 82 is configured to receive a configuration including at least a discarding rule for discarding at least one resource associated with a data unit; and transmit signaling based on the received configuration and/or a discarding activation request transmitted to the second network node 16b.

In some embodiments, the at least one resource is any one of a frame, and a packet, and the data unit includes any one of a protocol data unit and a service data unit associated with extended reality signaling.

In some other embodiments, the transmitted discarding activation request causes at least one of the first network node 16a, the second network node 16b, and the WD 22 to discard the at least one resource associated with the data unit.

In one embodiment, the first network node 16a is one of a centralized unit, a packet data convergence protocol entity, and distributed unit; and the second network node 16b is one of: the distributed unit when the first network node 16a is one of the centralized unit and the packet data convergence protocol entity; and the centralized unit when the first network node 16a is the distributed unit.

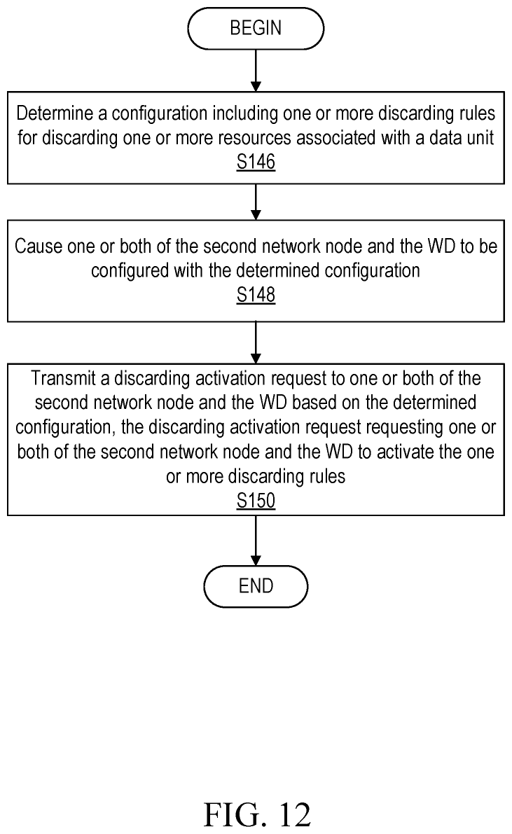

FIG. 12 is a flowchart of an exemplary process in a network node 16 (e.g., a first network node 16a). One or more blocks described herein may be performed by one or more elements of network node 16 such as by one or more of processing circuitry 68 (including the NN resource unit 32), processor 70, radio interface 62 and/or communication interface 60. Network node 16 such as via processing circuitry 68 and/or processor 70 and/or radio interface 62 and/or communication interface 60 is configured to determine (Block S146) a configuration including one or more discarding rules for discarding one or more resources associated with a data unit, cause (Block S148) one or both of the second network node 16b and the WD 22 to be configured with the determined configuration, and transmit (Block S150) a discarding activation request to one or both of the second network node 16b and the WD 22 based on the determined configuration. The discarding activation request requests one or both of the second network node 16b and the WD 22 to activate the one or more discarding rules.

In some embodiments, the one or more resources comprise any one of a frame and a packet.

In some other embodiments, the frame is one of a B-Frame, a P-Frame, and an I-Frame.

In some embodiments, the frame has a protocol data unit set tag, and at least one rule of the one or more discarding rules is usable for PDU set level discarding based on the protocol data unit set tag. The frame and at least one other frame which have the same protocol data unit set tag are discarded when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the activated one or more discarding rules trigger one or both of the second network node 16b and the WD 22 to discard the one or more resources associated with the data unit.

In some embodiments, the method further includes transmitting a discarding deactivation request to one or both of the second network node 16b and the WD 22. The discarding deactivation request requests one or both of the second network node 16b and the WD 22 to deactivate the one or more discarding rules.

In some other embodiments, the deactivated one or more discarding rules trigger one or both of the second network node 16b and the WD 22 to disable discarding of the one or more resources associated with the data unit.

In some embodiments, one or more of the first network node 16a comprises one of a centralized unit, a packet data convergence protocol entity, and distributed unit; and the second network node 16b comprises one of: the distributed unit when the first network node 16a is one of the centralized unit and the packet data convergence protocol entity; and the centralized unit when the first network node 16a is the distributed unit; and one or both of the one or more resources and the data unit is associated with extended reality signaling.

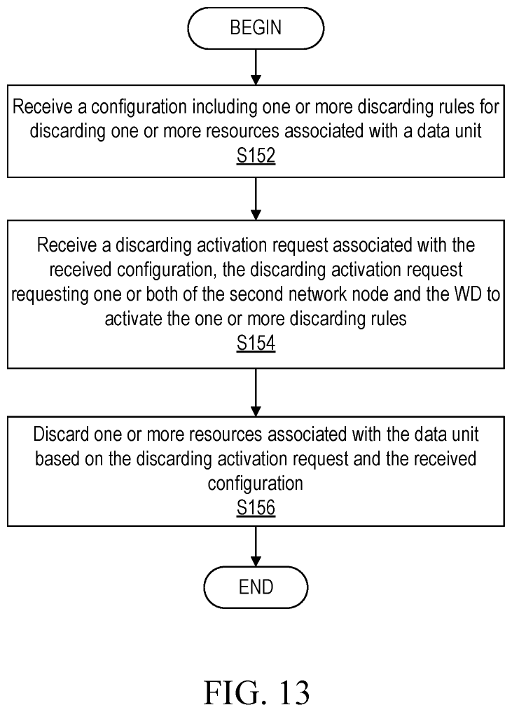

FIG. 13 is a flowchart of an exemplary process in a wireless device 22 according to some embodiments of the present disclosure. One or more blocks described herein may be performed by one or more elements of wireless device 22 such as by one or more of processing circuitry 84 (including the WD resource unit 34), processor 86, radio interface 82 and/or communication interface 60. Wireless device 22 such as via processing circuitry 84 and/or processor 86 and/or radio interface 82 is configured to receive (Block S152) a configuration including one or more discarding rules for discarding one or more resources associated with a data unit, receive (Block S154) a discarding activation request associated with the received configuration, where the discarding activation request requests one or both of the second network node 16b and the WD 22 to activate the one or more discarding rules, and discard (Block S156) one or more resources associated with the data unit based on the discarding activation request and the received configuration.

In some embodiments, the one or more resources comprise any one of a frame and a packet.

In some other embodiments, the frame is one of a B-Frame, a P-Frame, and an I-Frame.

In some embodiments, the frame has a protocol data unit set tag. At least one rule of the one or more discarding rules is usable for PDU set level discarding based on the protocol data unit set tag. The method further includes discarding the frame and at least one other frame having the same protocol data unit set tag when the at least one rule usable for PDU set level discarding is activated.

In some other embodiments, the data unit comprises any one of a protocol data unit, a service data unit, and a protocol data unit set.

In some embodiments, the one or more discarding rules are based on an importance level associated with one or both of the resource and the data unit.

In some other embodiments, the method further comprises activating the one or more discarding rules based on the discarding activation request, where the activated one or more discarding rules trigger the WD 22 to discard the one or more resources associated with the data unit.

In some embodiments, the method further comprises receiving a discarding deactivation request requesting one or both of the second network node 16b and the WD 22 to deactivate the one or more discarding rules.

In some other embodiments, the deactivated one or more discarding rules trigger the WD 22 to disable discarding of the one or more resources associated with the data unit.

In some embodiments, one or more of the first network node 16a comprises one of a centralized unit, a packet data convergence protocol entity, and distributed unit; and the second network node 16b comprises one of the distributed unit when the first network node 16a is one of the centralized unit and the packet data convergence protocol entity; and the centralized unit when the first network node 16a is the distributed unit; and one or both of the one or more resources and the data unit is associated with extended reality signaling.

Having described the general process flow of arrangements of the disclosure and having provided examples of hardware and software arrangements for implementing the processes and functions of the disclosure, the sections below provide details and examples of arrangements for signaling (e.g., over a control plane) one or more indications usable for dropping/discarding resources, e.g., associated with XR traffic data.

Some embodiments provide one or more network nodes 16 (e.g., a first network node 16a, a second network node 16b) and a WD 22 (which may be referred to as UE). Any network node 16 may be/comprise at least one of a gNB-CU, PDCP entity, a gNB-DU, an RLC entity, etc., and may be configured to determine a discarding rule to discard one or more resources, e.g., a PDU set. For example a first network node 16 may refer to gNB-DU, and a second network node 16 may refer to gNB-CU. A PDCP entity may be configured to discard PDUs (e.g., of an XR PDU Set). To discard, a discarding rule may be configured in the network (i.e., network node 16). The discarding rule may be configured using RRC at a second network node 16 (e.g., gNB-CU). A request may be transmitted from the second network node 16 (e.g., gNB-CU) (i.e., network node 16 hosting the PDCP entity) to the first network node 16 (e.g., gNB-DU) (i.e., network node 16 hosting the RLC entity) for the first network node 16 (e.g., gNB-DU) to activate the discarding rule in WD 22 (or deactivate it).

In some other embodiments, a network node 16 (e.g., an RLC entity) may be configured to discard PDUs. The discarding rule may be configured by a first network node 16 (e.g., gNB-DU) such as in lower layers. The configuration may be signaled to a second network node 16 (e.g., gNB-CU) which may transmit a request to the first network node 16 (e.g., gNB-DU) to activate the discarding rule in WD 22.

A dropping command may be transmitted from the first network node 16 (e.g., gNB-DU) to WD 22, which may occur after the second network node 16 (e.g., gNB-CU) signals to the first network node 16 (e.g., gNB-DU). In other words, the gNB-may CU query the first network node 16 (e.g., gNB-DU), and the first network node 16 (e.g., gNB-DU) may activate the rule via downlink control information (DCI) or MAC CE. WD 22 may be configured to follow (i.e., apply, perform an action based on) the discarding rule configured such as by the RLC/PDCP and activated by the second network node 16 (e.g., gNB-CU).

The discarding rule may be associated with Edge Computing and/or XR and/or Cloud Gaming. Edge Computing may be used to help 5G systems achieve a predetermined performance to enable XR and Cloud Gaming. In some embodiments, a dropping rule refers to a discarding rule.

Further, using a group PDCP timer to discard all PDCP SDUs and PDUs belonging to a specific PDU set (application data unit) may be beneficial from a capacity point of view. Other methods to predict whether a PDU Set meets predetermined conditions (e.g., requirements) may be used. In case at least one condition cannot be met, all PDCP SDUs and PDUs corresponding to the given PDU Set may be discarded based on a different type of XR application information such as the PDU Set packet size, the number of IP packets belonging to the PDU Set, or the type of PDU Set (e.g., pose, one of a set of video frames, or audio).

In XR application service, there are several types of video frames, e.g., I-frames are independent frames. That is, the decoder can decode I-frames without the assistance of other previously received frames. However, there are other types of frames such as B-frames or P-frames for which decoding depends on a successful reception of an independent frame and/or reception of other dependent frames, e.g., B-frames or P-frames.

Discarding B-Frames and P-Frames which are Associated to the I-Frames in DU

B-Frames and P-Frames may be tagged by its own PDU Set tag, as well as the I-Frame PDU Set Tag. When later PDCP entity (e.g., a network node 16 comprising a PDCP entity) indicates to discard a frame such as the I-Frame with the PDU Set tag, all the successive associated dependent frames, such as B-Frame and P-Frames, may be discarded until a new independent frame (e.g., I-frame based on the I-Frame PDU Set Tag) is received. Such discarding may be used when PDCP entity also indicates the explicit discarding based on the B-Frames or P-Frames PDU Set tags.

If a PDU Set transmission time is larger than a maximum PDU Set latency requirement, the PDCP layer can discard all the packets belonging to the PDU Set including packets already delivered to the lower layers than PDCP layer. In particular, RLC in first network node 16 (e.g., gNB-DU) entity may discard related packets according to a configuration by (i.e., transmitted by, performed by) a second network node 16 (e.g., gNB-CU). The configuration can include any information usable to identify and/or drop RLC packets related to the discarded PDCP packets.

In addition, the receiving PDCP entity in a WD 22 may be configured to be aware of the discarding configuration from the transmitting PDCP entity at a second network node 16 (e.g., gNB-CU) and the transmitting RLC entity at first network node 16 (e.g., gNB-DU). For instance, if a part of PDU Set bits are received at a WD 22 and the remaining bits (i.e., of the PDU Set bits) are discarded in a network (i.e., network node 16, access network 12, core network 14, intermediate network such as a cloud network), WD 22 may be configured to discard already received packets in a corresponding layer according to a predetermined configuration rule (e.g., a configuration including the discarding rule). Therefore, the network provides WD 22 with a configuration rule, e.g., via signaling such as described above to enable such behavior.

The solutions of the present disclosure for PDCP dropping may also be applicable to a WD 22 for uplink XR traffic. A gNB (e.g., network node 16) may explicitly communicate with WD 22 to control uplink traffic signaling. As a non-limiting example, parameters/commands related to dropping triggering may be included (e.g., in a configuration, discarding rule, etc.) such as latency requirements, bit rate, latency margins, bit rate margins, flows, traffic, Quality of Service Flow IDs (QFIs) to which the mechanism is applicable, an explicit command to trigger dropping based on a gNB observation on uplink transmissions, etc. The parameters for triggering conditions may be signaled by RRC configuration, and explicit dropping request to WD 22 may be RRC and/or MAC-CE such as to allow flexible and dynamic decision according to traffic variations.

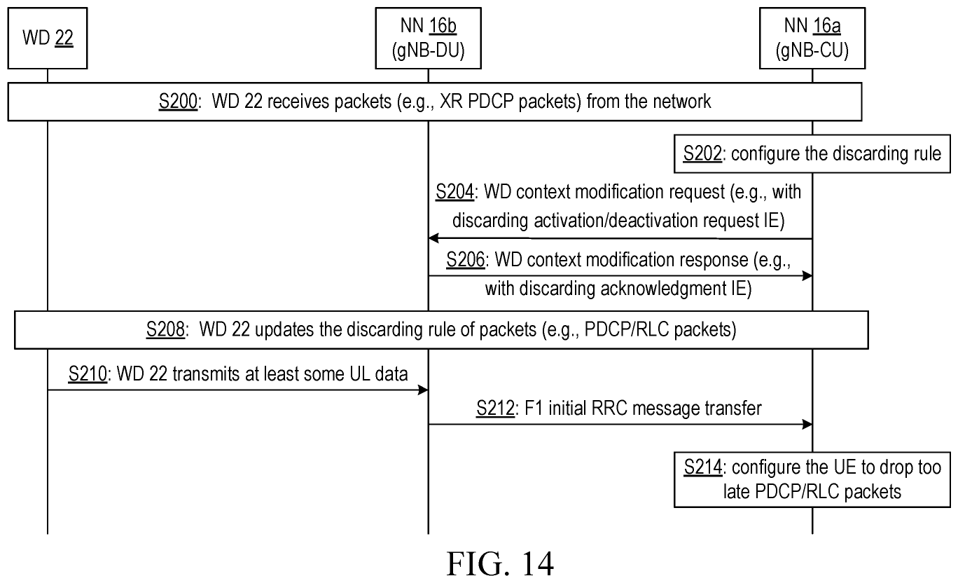

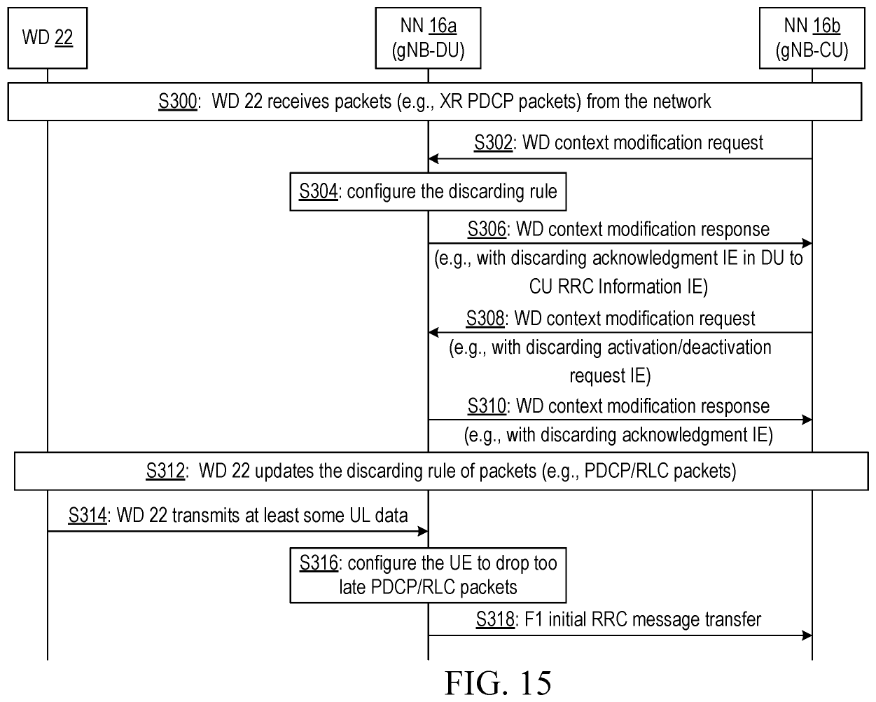

FIGS. 14 and 15 illustrate examples of network signaling that may occur between network nodes 16 (e.g., gNB-CU, gNB-DU) and WD 22.

### Nonlimiting Example of Discarding Rule Activation Configured by gNB-CU. e.g., PDCP Layer Configuration, During Modification (Shown in FIG. 14)

Step S200: WD 22 is receiving XR PDCP packets from the network (e.g., network nodes 16).

Step S202: Network node 16a (e.g., the gNB-CU), that is the entity handling the PDCP layer, decides whether to use (i.e., determines) a discarding rule configuration, which may be provided via RRC.

Step S204: Once the network node 16a (e.g., gNB-CU) configures WD 22 to discard PDCP packets, the network node 16a (e.g., gNB-CU) sends a discarding activation request to network node 16b (e.g., gNB-DU) to discard the packets. The activation by network node 16b (e.g., gNB-DU) may be via either a new DCI or MAC CE. Activation may also be indicated explicitly or implicitly in the RRC message configuring the feature in WD 22.

Activation may also be signaled over Xn to yet another entity holding the RLC layer, such as in case of for SN terminated bearers.

Step S206: in case of successful activation of the discarding rule, the network node 16b (e.g., gNB-DU) or the other entity where RLC layer is located may reply back to the network node 16a (e.g., gNB-CU) or entity where the PDCP layer is. The reply may include the result of the operation (i.e., activation and/or deactivation).

Step S208: WD 22 may follow (i.e., perform one or more actions such as receive/transmit based on) the indicated discarding rule.

Steps S210-S214: In case of UL transmission, the network node 16a (e.g., gNB-CU) configures WD 22 by including a rule to drop too late PDCP/RLC packets. Steps S204 and/or S206 for activation or deactivation (and/or any other steps) can be repeated.

Note 1: An F1 WD Context Setup procedure may be used instead of (and/or in conjunction with) the WD Context Modification procedure. Network node 16a (e.g., gNB-CU) may signal the discarding rule and/or the activation status during setup procedures.

Note 2: the above steps may be realized (i.e., performed) during RRC INACTIVE state, such as during Small data transmission of WD 22.

Note 3: Step S204 may be repeated to signal the Discarding Deactivation information element (IE) to network node 16b (e.g., gNB-DU) to deactivate the discarding rule and/or update WD behavior (i.e., configuration).

### Nonlimiting Example of Discarding Activation Configured by gNB-DU, e.g., RLC Configuration, (Shown in FIG. 15)

Step S300: WD 22 is receiving XR PDCP packets from the network.

Step S302: the node (i.e., network node 16b) hosting the PDCP entity queries network node 16a (e.g., gNB-DU) to configure the dropping rule. This step may also be performed by signaling over Xn to yet another entity holding the RLC layer, such as in case of for SN terminated bearers.

Step S304: The network node 16a (e.g., gNB-DU) decides whether to use (i.e., determines) a discarding rule configuration to be provided by MAC/PHY layers.

Step S306: in case network node 16a (e.g., gNB-DU) has configured a discarding rule, network node 16a (e.g., gNB-DU) or the other entity where RLC layer is located replies back to network node 16a (e.g., gNB-DU) and/or entity where the PDCP layer is with the discarding configuration. In case of F1, the discarding configuration may be transmitted as an Octet String in the DU to CU RRC

### Information.

Step S308: Once the dropping rule configuration is received via F1 or Xn, the PDCP entity decides for (i.e., determines) an action: Activation/deactivation. The PDCP entity may send an indication corresponding to the selected action to network node 16a (gNB-DU).

Step S310: In case of activation by network node 16a (e.g., gNB-DU), activation (i.e., activation request) can be transmitted via either a new DCI or MAC CE.

Step S312: WD 22 may follow the indicated discarding rule.

Steps S314-S318: In case of UL transmission, network node 16a (e.g., gNB-DU) configures WD 22 by including a rule to drop PDCP/RLC packets (e.g., drop packets that arrive late) and/or signals the configuration to network node 16b (e.g., gNB-CU).

Note 1: The F1 WD Context Setup procedure can be used instead of (or in conjunction with) the WD Context Modification procedure.

Note 2: the above steps can be realized (i.e., performed) during RRC INACTIVE state, such as during small data transmission of WD 22.

In another embodiment, the dropping rule configuration information can be signaled over E1P interface between two network nodes and/or entities of a network node 16 (e.g., gNB-CU-UP) (user plane)) and gNB-CU-CP (control plane)).

The following is a nonlimiting list of example embodiments:

Embodiment A1. A first network node configured to communicate with a wireless device (WD) and/or a second network node, the second network node being configured to communicate with the WD, the first network node configured to, and/or comprising a radio interface and/or a communication interface and/or comprising processing circuitry configured to:
determine a configuration including at least a discarding rule for discarding at least one resource associated with a data unit;
cause at least one of the WD and second network node to be configured with the determined configuration;
transmit a discarding activation request to the second network node based on the determined configuration; and
receive a discarding activation response indicating a successful activation of the at least discarding rule.

Embodiment A2. The first network node of Embodiment A1, wherein the at least one resource is any one of a frame, and a packet, and the data unit includes any one of a protocol data unit and a service data unit associated with extended reality signaling.

Embodiment A3. The first network node of any one of Embodiments A1 and A2, wherein the transmitted discarding activation request causes at least one of the first network node, the second network node, and the WD to discard the at least one resource associated with the data unit.

Embodiment A4. The first network node of any one of Embodiments A1-A3, wherein:
the first network node is one of a centralized unit, a packet data convergence protocol entity, and distributed unit; and
the second network node is one of:
   the distributed unit when the first network node is one of the centralized unit and the packet data convergence protocol entity; and
   the centralized unit when the first network node is the distributed unit.

Embodiment B1. A method implemented in a first network node configured to communicate with a wireless device (WD) and/or a second network node, the second network node being configured to communicate with the WD, the method comprising:
determining a configuration including at least a discarding rule for discarding at least one resource associated with a data unit;
causing at least one of the WD and second network node to be configured with the determined configuration;
transmitting a discarding activation request to the second network node based on the determined configuration; and
receiving a discarding activation response indicating a successful activation of the at least discarding rule.

Embodiment B2. The method of Embodiment B1, wherein the at least one resource is any one of a frame, and a packet, and the data unit includes any one of a protocol data unit and a service data unit associated with extended reality signaling.

Embodiment B3. The method of any one of Embodiments B1 and B2, wherein the transmitted discarding activation request causes at least one of the first network node, the second network node, and the WD to discard the at least one resource associated with the data unit.

Embodiment B4. The method of any one of Embodiments B1-B3, wherein:
the first network node is one of a centralized unit, a packet data convergence protocol entity, and distributed unit; and
the second network node is one of:
   the distributed unit when the first network node is one of the centralized unit and the packet data convergence protocol entity; and
   the centralized unit when the first network node is the distributed unit.

Embodiment C1. A wireless device (WD) configured to communicate with at least one of a first network node and a second network node, the WD configured to, and/or comprising a radio interface and/or processing circuitry configured to:
receive a configuration including at least a discarding rule for discarding at least one resource associated with a data unit; and
transmit signaling based on the received configuration and/or a discarding activation request transmitted to the second network node.

Embodiment C2. The WD of Embodiment C1, wherein the at least one resource is any one of a frame, and a packet, and the data unit includes any one of a protocol data unit and a service data unit associated with extended reality signaling.

Embodiment C3. The WD of any one of Embodiments C1 and C2, wherein the transmitted discarding activation request causes at least one of the first network node, the second network node, and the WD to discard the at least one resource associated with the data unit.

Embodiment C4. The WD of any one of Embodiments C1-C3, wherein:
the first network node is one of a centralized unit, a packet data convergence protocol entity, and distributed unit; and
the second network node is one of:
   the distributed unit when the first network node is one of the centralized unit and the packet data convergence protocol entity; and
   the centralized unit when the first network node is the distributed unit.

Embodiment D1. A method implemented in a wireless device (WD) configured to communicate with at least one of a first network node and a second network node, the method comprising:
receiving a configuration including at least a discarding rule for discarding at least one resource associated with a data unit; and
transmitting signaling based on the received configuration and/or a discarding activation request transmitted to the second network node.

Embodiment D2. The method of Embodiment D1, wherein the at least one resource is any one of a frame, and a packet, and the data unit includes any one of a protocol data unit and a service data unit associated with extended reality signaling.

Embodiment D3. The method of any one of Embodiments D1 and D2, wherein the transmitted discarding activation request causes at least one of the first network node, the second network node, and the WD to discard the at least one resource associated with the data unit.

Embodiment D4. The method of any one of Embodiments D1-D3, wherein:
the first network node is one of a centralized unit, a packet data convergence protocol entity, and distributed unit; and
the second network node is one of:
   the distributed unit when the first network node is one of the centralized unit and the packet data convergence protocol entity; and
   the centralized unit when the first network node is the distributed unit.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ADU Application Data Unit
AR Augmented Reality
ARP Allocation and Retention Priority
AS Access Stratrum
CQI Channel Quality Indicator
DL Downlink
DRB Data Radio Bearer
eMBB Enhanced Mobile Broadband
Fps Frames Per Second
GTP-U General Packet Radio System Tunnelling Protocol User Plane
IP Internet Protocol
LCG Logical Channel Group
LCID Logical Channel Identity
MAC Medium Access Control
mMTC Massive Machine Type Communications
MR Mixed Reality
NAS Non-access Stratrum
NR New Radio
PDB Packet Delay Budget
PDCP Packet Data Convergence Protocol
PDR Packet Detection Rules
PDU Protocol Data Unit
PDU Protocol Data Unit
QFI QoS Flow ID
Qos Quality of Service
RAN Radio Access Network
RLC Radio Link Control
SDAP Service Data Adaptation Protocol
SDU Service Data Unit
SMF Session Management Function
TB Transport Block
TTI Transmission Time Interval
UL Uplink
UPF User Plane Function
URLLC Ultra-reliable low-latency communications
VOIP Voice over IP
VR Virtual Reality
xR extended Radio/Reality

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate with a wireless device, WD, and a second network node, the first network node comprising processing circuitry configured to:
determine a configuration including one or more discarding rules for discarding one or more resources associated with a data unit;
cause one or both of the second network node and the WD to be configured with the determined configuration; and
cause transmission of a discarding activation request to one or both of the second network node and the WD based on the determined configuration, the discarding activation request requesting one or both of the second network node and the WD to activate the one or more discarding rules.

2. The first network node of claim 1, wherein the one or more resources comprise any one of a frame and a packet.

3. The first network node of claim 2, wherein the frame is one of a B-Frame, a P-Frame, and an I-Frame.

4. The first network node of claim 2, wherein the frame has a protocol data unit set tag, and at least one rule of the one or more discarding rules is usable for PDU set level discarding based on the protocol data unit set tag, the frame and at least one other frame having the same protocol data unit set tag being discarded when the at least one rule usable for PDU set level discarding is activated.

5. The first network node of claim 1, wherein the data unit comprises any one of a protocol data unit, a service data unit, and a protocol data unit set.

6. The first network node of claim 1, wherein the one or more discarding rules are based on an importance level associated with one or both of the resource and the data unit.

7. The first network node of claim 1, wherein the activated one or more discarding rules trigger one or both of the second network node and the WD to discard the one or more resources associated with the data unit.

8. The first network node of claim 1, wherein the processing circuitry is further configured to:
cause transmission of a discarding deactivation request to one or both of the second network node and the WD, the discarding deactivation request requesting one or both of the second network node and the WD to deactivate the one or more discarding rules.

9. The first network node of claim 8, wherein the deactivated one or more discarding rules trigger one or both of the second network node and the WD to disable discarding of the one or more resources associated with the data unit.

10. The first network node of claim 1, wherein one or more of:
the first network node comprises one of a centralized unit, a packet data convergence protocol entity, and distributed unit; and
the second network node comprises one of:
the distributed unit when the first network node is one of the centralized unit and the packet data convergence protocol entity; and
the centralized unit when the first network node is the distributed unit; and
one or both of the one or more resources and the data unit is associated with extended reality signaling.

11. A method in a first network node configured to communicate with a wireless device, WD, and a second network node, the method comprising:
determining a configuration including one or more discarding rules for discarding one or more resources associated with a data unit;
causing one or both of the second network node and the WD to be configured with the determined configuration; and
transmitting a discarding activation request to one or both of the second network node and the WD based on the determined configuration, the discarding activation request requesting one or both of the second network node and the WD to activate the one or more discarding rules.

12.-20. (canceled)

21. A wireless device, WD, configured to communicate with a first network node and a second network node, the WD comprising processing circuitry configured to:
receive a configuration including one or more discarding rules for discarding one or more resources associated with a data unit;
receive a discarding activation request associated with the received configuration, the discarding activation request requesting one or both of the second network node and the WD to activate the one or more discarding rules; and
discard one or more resources associated with the data unit based on the discarding activation request and the received configuration.

22. The WD of claim 21, wherein the one or more resources comprise any one of a frame and a packet, and wherein the frame is one of a B-Frame, a P-Frame, and an I-Frame.

23. (canceled)

24. The WD of claim 22, wherein the frame has a protocol data unit set tag, at least one rule of the one or more discarding rules is usable for PDU set level discarding based on the protocol data unit set tag, and the method further includes:
discarding the frame and at least one other frame having the same protocol data unit set tag when the at least one rule usable for PDU set level discarding is activated.

25. The WD of claim 21, wherein one or both:
the data unit comprises any one of a protocol data unit, a service data unit, and a protocol data unit set; and
the one or more discarding rules are based on an importance level associated with one or both of the resource and the data unit.

26. (canceled)

27. The WD of claim 21, wherein the processing circuitry is further configured to one or both:
activate the one or more discarding rules based on the discarding activation request, the activated one or more discarding rules trigger the WD to discard the one or more resources associated with the data unit;
receive a discarding deactivation request requesting one or both of the second network node and the WD to deactivate the one or more discarding rules, wherein the deactivated one or more discarding rules trigger the WD to disable discarding of the one or more resources associated with the data unit.

28.-30. (canceled)

31. A method in a wireless device, WD, configured to communicate with a first network node and a second network node, the method comprising:
receiving a configuration including one or more discarding rules for discarding one or more resources associated with a data unit;
receiving a discarding activation request associated with the received configuration, the discarding activation request requesting one or both of the second network node and the WD to activate the one or more discarding rules; and
discarding one or more resources associated with the data unit based on the discarding activation request and the received configuration.

32. (canceled)

33. (canceled)

34. The method of claim 31, wherein the frame has a protocol data unit set tag, at least one rule of the one or more discarding rules is usable for PDU set level discarding based on the protocol data unit set tag, and the method further includes:
discarding the frame and at least one other frame having the same protocol data unit set tag when the at least one rule usable for PDU set level discarding is activated.

35. (canceled)

36. (canceled)

37. The method of claim 31, wherein the method further comprises:
activating the one or more discarding rules based on the discarding activation request, the activated one or more discarding rules trigger the WD to discard the one or more resources associated with the data unit.

38. The method of claim 31, wherein the method further comprises:
receiving a discarding deactivation request requesting one or both of the second network node and the WD to deactivate the one or more discarding rules.

39. (canceled)

40. (canceled)
